(19) United States
(12) Patent Application Publication
(10) Pub. No.: US 2009/0186117 A1
(43) Pub. Date: Jul. 23, 2009

(54) Stress-Reducing Device and a Method of Using Same

(75) Inventors: Manon Danielle BELZILE, Fairfield, VT (US); Eric Michael LaPine, Fairfax, VT (US); Sarah Kathleen OVERFIELD, Colchester, VT (US); James Osborne PLUMPTON, Enosburg Falls, VT (US)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: HUSKY INJECTION MOLDING SYSTEMS LTD., Bolton (CA)

(21) Appl. No.: 12/015,977

(22) Filed: Jan. 17, 2008

(51) Int. Cl. B29C 45/14

(52) U.S. Cl. 425/572

(57) ABSTRACT

There is provided a stress-reducing device and a method of using same. The stress reducing device comprises an insert positionable, in use, proximate to an area of a fluid-carrying conduit that experiences increased tensile stress concentration, the insert being configured to apply, in use, compressive force onto the area.

### FIELD OF THE INVENTION

The present invention generally relates to, but is not limited to, a molding system, and more specifically the present invention relates to, but is not limited to, a stress-reducing device and a method of using same.

### BACKGROUND OF THE INVENTION

Molding is a process by virtue of which a molded article can be formed from molding material by using a molding system. Various molded articles can be formed by using the molding process, such as an injection molding process. One example of the molded article that can be formed, for example, from polyethylene terephthalate (PET) material is a preform that is capable of being subsequently blow-molded into a beverage container, such as, a bottle and the like. Other examples of the molded articles include thin-wall containers (i.e. yogurt containers, cups, etc), medical appliances and the like.

In the early days of injection molding, a single-cavity mold for producing a single molded article per molding cycle was typically deployed. Within the single-cavity mold, typically, melt would be delivered from a plasticizing unit to a molding cavity, defined within the single-cavity mold, via a sprue. With developments in the injection molding art, multi-cavity molds have been introduced with an outlook to increase the number of molded articles manufactured per molding cycle.

Typically, within the multi-cavity mold, the melt is delivered from the plasticizing unit to each of a plurality of molding cavities of the multi-cavity mold through a melt distribution network, also known to those of skill in the art, as a “hot runner”. A typical example if the hot runner is illustrated with reference to FIG. 1, which depicts a perspective view of a hot runner manifold 100 with partially cut-away portions for ease of illustration of the internal structure thereof.

Structure of the hot runner manifold 100 of FIG. 1 is well known to those of skill in the art and, as such, only a brief description will be presented herein. Within the specific example being presented herein, the hot runner manifold 100 is configured as a four-drop manifold or, in other words, the hot runner manifold 100 can be configured to supply melt to a mold (not depicted) having four molding cavities defined therein.

The hot runner manifold 100 includes a base 102. The base 102 houses an internal melt distribution network 104. The internal melt distribution network 104 starts at an inlet 106 (the inlet 106 for accepting, in use, a stream of melt from a sprue of the plasticizing unit, both of which are not depicted in FIG. 1, but known to those of skill in the art) and terminates in four instances of a manifold 108, each instance of the manifold 108 for accepting, in use, a valve bushing (not depicted) for conveying melt towards a nozzle assembly (not depicted) and, eventually, to a molding cavity (not depicted) of a mold (not depicted). Each instance of the nozzle assembly (not depicted) is generally referred to in the art as a “drop”.

The internal melt distribution network 104 can be implemented in many different shapes, depending on the number of cavities (not depicted) of the mold (not depicted) that the hot runner manifold 100 is to be used with. Some examples of known shapes for implementing the internal melt distribution network 104 include an “H” shape, an “X” shape and the like (for the avoidance of doubt, the term “shape” refers to an arrangement of various runners within the internal melt distribution network 104).

Irrespective of the actual shape used, the internal melt distribution network 104 comprises one or more intersections, where one runner of the internal melt distribution network 104 intersects another runner of the internal melt distribution network 104. One such intersection is depicted at 112 in FIG. 1.

To complete the description of FIG. 1, the base 102 also houses a heating arrangement 110. The heating arrangement 110 includes one or more heaters and is configured to maintain, in use, the internal melt distribution network 104 at an operational temperature, which is selected such that to maintain the melt flowing via the internal melt distribution network 104 at a temperature at which the melt is conducive to flowing through the internal melt distribution network 104. The base 102 includes a number of additional elements, known to those skilled in the art, some of which include (i) coupling bores 114 for accepting, in use, fasteners that couple the inlet 106 to the sprue (not depicted), (ii) a set of two receptacles 116 for accepting, in use, fasteners that attach the hot runner manifold 100 to a manifold plate (not depicted), (iii) a ground screw receptacle 118 and (iv) other components of the hot runner manifold 100 known to those of skill in the art.

An apparatus of this type is known in the art and is used widely in the field of injection molding and the like. An example of the hot runner manifold 100 is disclosed in a US patent issued to Jenko on Dec. 30, 2003 and bearing a U.S. Pat. No. 6,669,462. This patent teaches, as an example, an apparatus for injecting plastic material that comprises a manifold having a melt channel and a flat sealing surface, and a nozzle assembly seated directly against the flat sealing surface. The nozzle assembly includes a nozzle body having an axial channel aligned, in use, with the melt channel in the manifold for communicating a flow of material therein. The nozzle body has a non-flat sealing surface adjacent the flat sealing surface, thereby forming a sealing interface to seal the nozzle body with the manifold. The flat sealing surface may be on an end of a bushing mounted into the manifold. The non-flat surface may have a conical profile, preferably defined by an angle less than one degree, and preferably between 0.2 to 0.4 degrees, from a plane parallel to the flat sealing surface. The non-flat surface may have a spherical profile, preferably having a radius between 350 mm and 4000 mm.

### SUMMARY OF THE INVENTION

According to a first broad aspect of the present invention, there is provided a stress reducing device comprising an insert positionable, in use, proximate to an area of a fluid-carrying conduit that experiences increased tensile stress concentration, the insert being configured to apply, in use, compressive force onto the area.

According to a second broad aspect of the present invention, there is provided a hot runner comprising (i) a body housing an internal melt distribution network for distributing melt from an inlet to a drop; a heating arrangement, configured to maintain, in use, the internal melt distribution network at an operational temperature; the internal melt distribution network comprising an area that experiences increased tensile stress concentration; and (ii) a stress reducing device including an insert positionable, in use, proximate to the area; the insert being configured to apply, in use, compressive force onto the area.

According to a third broad aspect of the present invention, there is provided a stress reducing device comprising an insert positionable, in use, proximate to an area within a structure; the area that experiences increased tensile stress concentration, the insert being configured to apply, in use, compressive force onto the area.

According to a fourth broad aspect of the present invention, there is provided a method for local reducing of tensile stress concentration in an area of a fluid-carrying conduit that experiences, in use, higher tensile stress concentration, the method comprising applying an insert proximate to the area, the insert being configured to apply, in use, compressive force onto the area to at least reduce tensile stress experienced in the area.

### DESCRIPTION OF THE DRAWINGS

A better understanding of the non-limiting embodiments of the present invention (including alternatives and/or variations thereof) may be obtained with reference to the detailed description of the non-limiting embodiments along with the following drawings, in which:

FIG. 1 depicts a perspective view of a hot runner manifold 100 with partially cut-away portions for ease of illustration of the internal structure thereof, the hot runner manifold 100 implemented in accordance with known techniques.

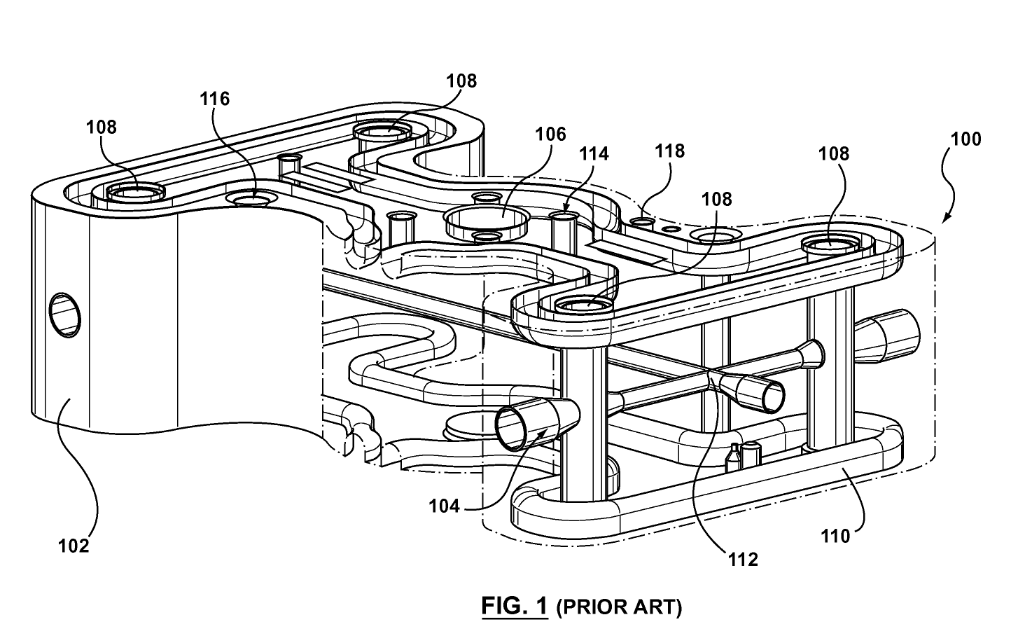

FIG. 2 depicts a portion of the hot runner manifold 100 of FIG. 1, the hot runner manifold 100 implementing a stress reducing device 202, the stress reducing device 202 implemented in accordance with a non-limiting embodiment of the present invention.

FIG. 3 depicts a cross section of a portion of the hot runner manifold 100 of FIG. 1, the hot runner manifold 100 implementing a stress reducing device 302, the stress reducing device 302 implemented in accordance with another non-limiting embodiment of the present invention.

FIG. 4A depicts a first alternative for implementing the stress reducing device 302 of FIG. 3 and FIG. 4B depicts a second alternative for implementing the stress reducing device 302 of FIG. 3.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION OF EMBODIMENTS

Embodiments of the present invention have been developed as a result of inventors' appreciation of certain problems associated with known designs of hot runners, such as the hot runner manifold 100. For example, inventors appreciated that during application of injection pressure, certain areas within the internal melt distribution network 104 demonstrate high local tensile stress concentration. In some applications (such as, for example, while using the hot runner manifold 100 with a mold for producing thin-walled molded articles), the so-endured stresses can be higher than endurance limits of a material used for manufacturing of the hot runner manifold 100 and may cause the hot runner manifold 100 to crack and, therefore, lead to premature failure. Naturally, this is an undesirable situation since the hot runner manifold 100 is typically an expensive item and premature replacement of the hot runner manifold 100 may not be desirable to an entity operating the hot runner manifold 100. Also, if this occurs while the hot runner manifold 100 is under warranty, this may be undesirable to a vendor of the hot runner manifold 100.

One solution employed in the industry has been to increase the strength of the material used for producing the hot runner manifold 100 and, therefore, increase the material endurance limit. Even though this is a relatively straightforward solution, it is not completely satisfactory. Firstly, generally speaking, the stronger a given material is, the more expensive it is. Secondly, the stronger material may not be available in all parts of the world and, depending where manufacturing facilities are, sourcing the stronger material from a remote location may significantly add to the manufacturing costs. Additionally, stronger material may not be conducive to being machined using standard tooling and may require specialized and/or expensive tooling. Finally, a material with a required level of strength sufficient for some high-pressure applications may simply be commercially unavailable. Some or all of these issues lead to increased costs, which due to today's competitive nature of the industry has to be absorbed, almost in its entirety, by the manufacturer.

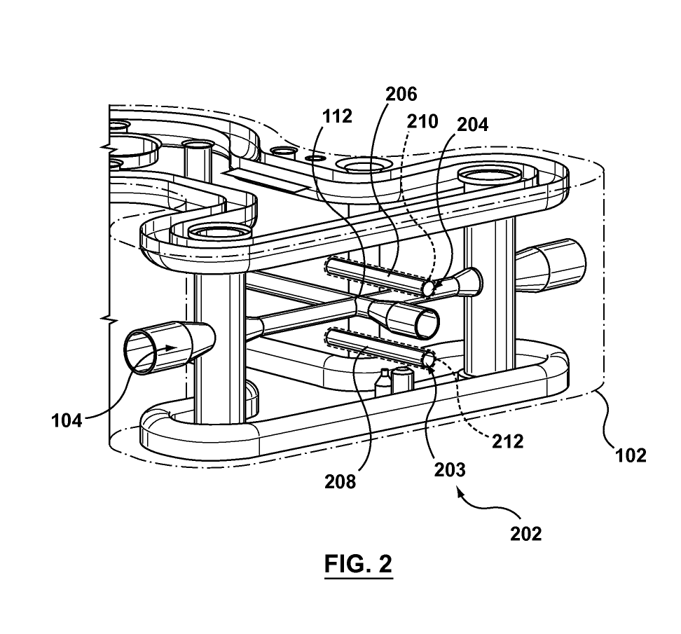

Reference is now made to FIG. 2, which depicts a portion of the hot runner manifold 100, which is suitable for implementing embodiments of the present invention. Within the illustration to be presented herein below, the intersection 112 can be considered to be an “area that experiences, in use, increased tensile stress concentration” or, simply, an “increased tensile stress area”.

Within this non-limiting embodiment of the present invention, the hot runner manifold 100 includes a stress reducing device 202, which comprises an insert 203 that is positionable locally (i.e. proximate) vis-à-vis the intersection 112 to reduce the tensile stress experienced by this area during use. Within the specific non-limiting embodiment of the present invention, the insert 203 is implemented as an expanding stress reducing insert 204.

Generally speaking, the expanding stress reducing insert 204 is made of a material having a relatively high thermal expansion index. The term “relatively high thermal expansion index” will now be explained in greater detail. Within this embodiment of the present invention, material used for manufacturing the expanding stress reducing insert 204 is associated with a first thermal expansion index. Within these embodiments of the present invention, material used for manufacturing of the body 102 can be said to be associated with a second thermal expansion index. Accordingly, within these non-limiting embodiments of the present invention, material used for the expanding stress reducing insert 204 is so selected such that the first thermal expansion index is greater that the second thermal expansion index. For ease of reference, material used for the first rod 206 and the second rod 208 will sometimes be referred to herein below as “first material” and material used for the body 102 will sometimes be referred to herein below as “second material” (or vice versa).

More specifically, within this non-limiting embodiment of the present invention, the expanding stress reducing insert 204 comprises two rods—a first rod 206 and a second rod 208. Each of the first rod 206 and the second rod 208 is positionable, in use, within a first receptacle 210 and a second receptacle 212 (both depicted in FIG. 2 in a dotted line), respectively, defined within the body 102. In use, the first receptacle 210 and the second receptacle 212 are defined such that when the first rod 206 and the second rod 208 are positioned therein, the first rod 206 and the second rod 208 are located proximate to the intersection 112 (i.e. the area of the hot runner manifold 100, which can be said to be increased tensile stress area and where it is desirable to reduce such tensile stress). Within the specific non-limiting implementation, the first receptacle 210 and the second receptacle 212 are located, respectively, above and below the intersection 112. It should be expressly noted, however, that the number of the first rod 206 and the second rod 208 used, the exact positioning of the first receptacle 210 and the second receptacle 212, the shape of the first rod 206 and the second rod 208 are not particularly limited and the illustration in FIG. 2 is meant to be an illustration of just a single embodiment thereof. Those skilled in the art will appreciate other equivalent implementation thereof without departing from the teaching of embodiments of the present invention.

It should be expressly understood that even though in the specific illustrated embodiment of the present invention, the first rod 206 and the second rod 208 are located proximate to and, respectively, above and below the intersection 112, in alternative non-limiting embodiments of the present invention, the first rod 206 and the second rod 208 can be located proximate to and, respectively, to the left and to the right the intersection 112 (provided that in those embodiments, the intersection 112 is rotated by approximately 90 degrees clockwise from the position in FIG. 2). In other words, it can be said that the first rod 206 and the second rod 208 are located proximate to and, respectively, at a first location and a second location relative to the intersection 112, the first location and the second location being selected based on the desired compressive force to be exerted by the first rod 206 and the second rod 208 onto the intersection 112. It should be also noted that even though in the illustration of FIG. 2, the first rod 206 and the second rod 208 are located symmetrically relative to the intersection 112, in alternative non-limiting embodiments of the present invention, they can be located asymmetrically. It should be expressly understood that exact location will depend on the desired level of compressive force to be exerted and a stress pattern experienced by the intersection 112 (which can be determined by known techniques, such as Finite Element Analysis and the like).

Relationship between the first thermal expansion index and the second thermal expansion index results in the following phenomenon. During use (i.e. when the hot runner manifold 100 is subjected to an operational temperature, which will of course vary depending on the particular application), the first rod 206 and the second rod 208 expand at a larger rate compared to the surrounding area of the body 102. Accordingly, faster expansion of the first rod 206 and the second rod 208 results in application of a compressive force onto the intersection 112 (i.e. the area of the hot runner manifold 100 which can be said to be increased tensile stress area and where it is desirable to reduce such tensile stress). This application of the compressive force onto the intersection 112 can be said to lead to a technical effect of this embodiment of the present invention, i.e. reduction of the tensile stress experienced, in use, at the intersection 112.

Within a specific non-limiting implementation of this embodiment of the present invention, the body 102 can be manufactured from a material having a thermal expansion index in a range of between approximately 11 and approximately 13 μm/m° C. and the first rod 206 and the second rod 208 can be manufactured from a material having a thermal expansion index of or above approximately 15 μm/m° C. It should be expressly understood that these ranges are meant as an example only and that the ranges can be different as long as the thermal expansion index of the material used for the first rod 206 and the second rod 208 is greater than the thermal expansion index of the material used for the body 102.

In some embodiments of the present invention, the first receptacle 210 and the second receptacle 212 can be drilled into the body 102, however, other manufacturing techniques for the first receptacle 210 and the second receptacle 212 can be used, as will become apparent to those of skill in the art.

In some embodiments of the present invention, size associated with the first rod 206 and the second rod 208 (i.e. diameter in this case) can be selected relative to size of the first receptacle 210 and the second receptacle 212 (i.e. internal diameter in this case) such that they provide for interference fit therebetween at room temperature. In alternative non-limiting embodiments of the present invention, size associated with the first rod 206 and the second rod 208 (i.e. diameter in this case) can be selected relative to size of the first receptacle 210 and the second receptacle 212 (i.e. internal diameter in this case) such that they do not provide for interference fit therebetween at room temperature. The selection can be made depending on the amount of compressive force desired at the operating temperature. For example, if it is desired to have more compressive force exerted onto the intersection 112, the interference fit implementation may be more suitable. Alternatively, in order to achieve exertion of the higher compressive force, it may be suitable to select a higher differential of the thermal expansion index of the material used for the first rod 206 and the second rod 208 and the material used for the body 102.

In some embodiments of the present invention, a respective tolerance associated with (a) the first receptacle 210 and the first rod 206 is substantially similar to a respective tolerance associated with (b) the second receptacle 212 and the second rod 208. This has an additional technical effect that, in use, the compressive force exerted by the first rod 206 and the second rod 208 onto the intersection 112 are substantially the same. In alternative non-limiting embodiments of the present invention, the respective tolerance can be different. This is particularly applicable, where it is desired for the compressive force exerted by the first rod 206 and the second 208 to be different.

In a specific non-limiting implementation of the present invention, each of the first receptacle 210 and the second receptacle 212 has an internal diameter of 5 millimeters; each of the first rod 206 and the second rod 208 has a diameter of 5 millimeters; and each of the first receptacle 210 and the second receptacle 212 is positioned by a distance of 10 millimeters away from the intersection 112 (namely, above and below thereof).

To facilitate installation of the first rod 206 and the second rod 208, especially but not limited to those embodiments where the sizes are selected to provide interference fit, the first rod 206 and the second rod 208 can be chilled prior to installation. For example, the first rod 206 and the second rod 208 can be chilled in liquid nitrogen to a temperature of approximately −200 (minus two hundred) degrees Centigrade. Other chilling methods can, of course, be used. Alternatively or additionally, the hot runner manifold 100 can itself be heated, for example, in an oven. Naturally, it should be appreciated that if the hot runner manifold 100 is to be heated, it should be heated only to a temperature which is below a heat treat temperature associated with the material used for manufacturing of the hot runner manifold 100. In other words, the hot runner manifold 100 can be heated to a temperature high enough to facilitate installation of the first rod 206 and the second rod 208, but low enough to prevent negative changes in properties associated with the material used for manufacturing the hot runner manifold 100.

Within these embodiments of the present invention, the amount of compressive force exerted by the first rod 206 and the second rod 208 can be adjusted either by selecting the thermal expansion index of the first material used for manufacturing of the first rod 206 and the second rod 208 or by selecting/adjusting location of the first rod 206 and the second rod 208 relative the intersection 112. In other non-limiting embodiments of the present invention, each of the first rod 206 and the second rod 208 can be provided with an internal bore, which can be threaded. This is provided for an auxiliary adjustment of compressive force. For example, should a higher compressive force be desired, a screw can be inserted into the internal bore to increase the compressive force exerted during use. Within these embodiments of the present invention, the internal bore and the screw cooperate to provide an “auxiliary force adjustment mechanism”, which can take a number of alternative form factors, of course.

Accordingly, within the embodiment of FIG. 2, there is provided the stress reducing device 202 for targeted application in the area that experiences, in use, increased tensile stress and where it is desirable to reduce the so-experienced tensile stress (such as, for example, the intersection 112 of the internal melt distribution network 104 of the hot runner manifold 100), the stress reducing device 202 implemented as the expanding stress reducing insert 204, the expanding stress reducing insert 204 being associated with the first thermal expansion index that is higher than the second thermal expansion index associated with the material used for manufacturing the body 102 of the hot runner manifold 100. Application of the expanding stress reducing insert 204 produces compressive force onto the intersection 112 to at least mitigate or substantially minimize high tensile force concentration, in use, within the intersection 112.

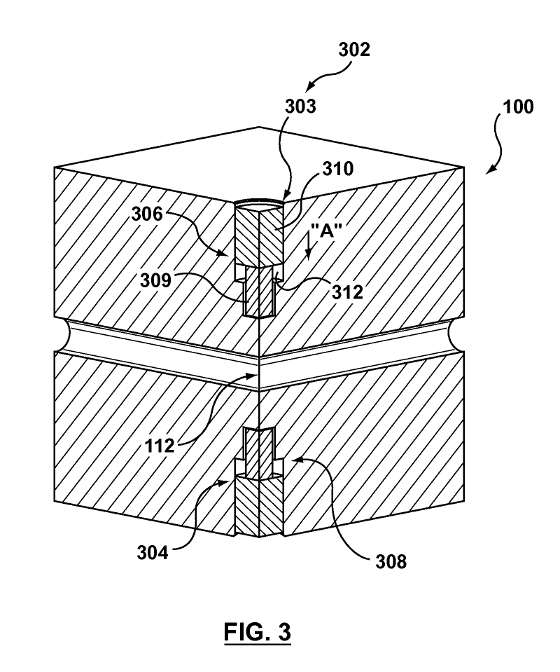

Reference to FIG. 3 is now made. FIG. 3 depicts a cross-section of a portion of the hot runner manifold 100, which is suitable for implementing embodiments of the present invention. Within the illustration to be presented herein below, the intersection 112 can be considered to be the area that experiences, in use, increased tensile stress and where it is desirable to reduce the tensile stress.

Within this non-limiting embodiment of the present invention, the hot runner manifold 100 includes a stress reducing device 302, which comprises an insert 303 that is positionable locally (i.e. proximate) vis-à-vis the intersection 112 to reduce the tensile stress experienced by this area during use. Within the specific non-limiting embodiment of the present invention, the insert 303 is implemented as a mechanical stress reducing insert 304.

More specifically, within this non-limiting embodiment of the present invention, the mechanical stress reducing insert 304 comprises two insert members—a first insert member 306 and a second insert member 308. Construction of first insert member 306 and the second insert member 308 can be substantially the same and, as such, only construction of the first insert member 306 will be explained in detail below, but the description of which will equally apply to the second insert member 308.

Each of the first insert member 306 and the second insert member 308 is positionable, in use, at a location proximate to and, respectively, above and below the intersection 112 (i.e. the area of the hot runner manifold 100 which can be said to be increased tensile stress area and where it is desirable to reduce such tensile stress). It should be expressly understood that even though in the specific illustrated embodiment of the present invention, the first insert member 306 and the second insert member 308 are located proximate to and, respectively, above and below the intersection 112, in alternative non-limiting embodiments of the present invention, the first insert member 306 and the second insert member 308 are located proximate to and, respectively, to the left and to the right the intersection 112 (provided that in those embodiments, the intersection 112 is rotated by approximately 90 degrees clockwise from the position in FIG. 3). In other words, it can be said that generally speaking, that the first insert member 306 and the second insert member 308 are located proximate to and, respectively, at a first location and a second location relative to the intersection 112, the first location and the second location being spaced apart in opposite directions, symmetrically to the intersection 112.

The first insert member 306 comprises a load inducing piece 309 and a retaining piece 310. The load inducing piece 309 and the retaining piece 310 are positionable in a receptacle 312 defined within the body 102. The load inducing piece 309 can comprise a generally cylindrical load piece. The retaining piece 310 can comprise a set screw and is configured to operatively retain the load inducing piece 309 within the receptacle 312.

The load inducing piece 309 and the retaining piece 310 cooperate, in use, to exert compressive force in a direction depicted in FIG. 3 at “A” (which is, naturally, reversed for the second insert member 308). Accordingly, compressive force exercised by the load inducing piece 309 and the retaining piece 310 results in application of a compressive force onto the intersection 112 (i.e. the area of the hot runner manifold 100 which can be said to be increased tensile stress area and where it is desirable to reduce such tensile stress). This application of the compressive force onto the intersection 112 can be said to lead to a technical effect of this embodiment of the present invention, i.e. reduction of the tensile stress experienced, in use, at the intersection 112.

In some embodiments of the present invention, the load inducing piece 309 can be manufactured from the same material as the body 102 of the hot runner manifold 100. Within these embodiments of the present invention, the amount of compressive force exerted by the load inducing piece 309 can be adjusted by torquing the retaining piece 310. In alternative non-limiting embodiment of the present invention, the load inducing piece 309 can be manufactured from a first material having a relatively high thermal expansion index vis-à-vis a second material that is used for manufacturing the body 102. Within these embodiments of the present invention, the amount of compressive force exerted by the load inducing piece 309 can be adjusted by torquing the retaining piece 310 and/or by selecting the thermal expansion index of the first material.

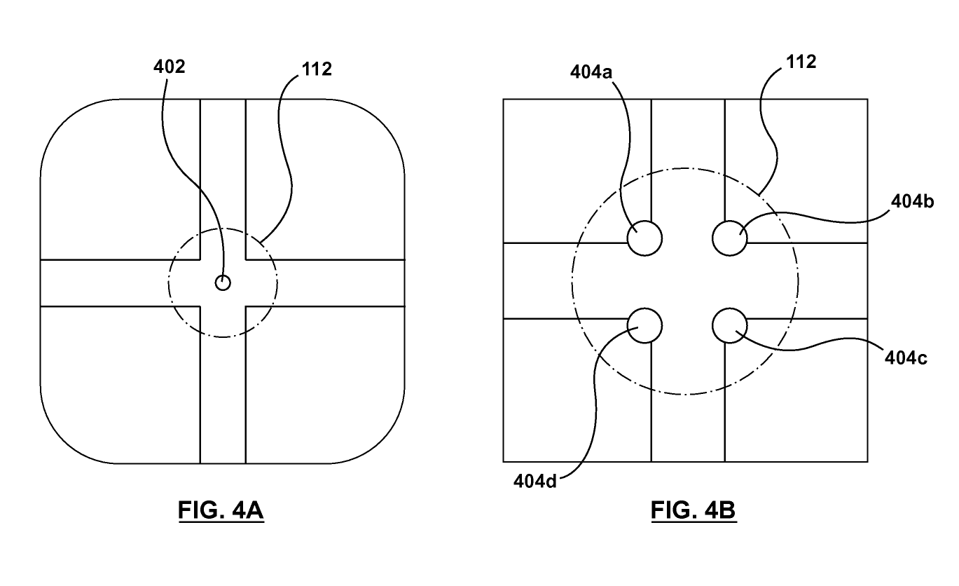

In some embodiments of the present invention, a first set of the first insert member 306 and the second insert member 308 are provided for a targeted site (i.e. the intersection 112). This is illustrated in FIG. 4A, which depicts an embodiment where the first set is used and is depicted at 402. In alternative non-limiting embodiments of the present invention, two or more sets (i.e. at least a first set and a second set, the second set being substantially the same as the first set) of the first insert member 306 and the second insert member 308 can be provided for the targeted site (i.e. the intersection 112). This is depicted in FIG. 4B at 404a, 404b, 404c and 404d, where four sets of the first insert member 306 and the second insert member 308 are used. Generally speaking, embodiment depicted in FIG. 4A is more applicable to the intersection 112 of a smaller cross-section, while the embodiment of FIG. 4B is more applicable to the intersection 112 of a larger cross-section.

Accordingly, within the embodiment of FIG. 3, there is provided the stress reducing device 302 for targeted application in the area that experiences, in use, increased tensile stress and where it is desirable to reduce this tensile stress (such as, for example, the intersection 112 of the internal melt distribution network 104 of the hot runner manifold 100, the stress reducing device 302 implemented as the mechanical stress reducing insert 304, the mechanical stress reducing insert 304 configured to apply compressive force onto the intersection 112 to at least mitigate or substantially minimize high tensile force concentration, in use, within the intersection 112.

Even though embodiments of the present invention have been described in the context of the intersection 112 being part of the internal melt distribution network 104 of the hot runner manifold 100, this need not be considered as a limitation of all embodiments of the present invention. In some embodiments of the present invention, teachings of the present invention can be implemented to a portion (such as, an intersection) in a fluid-carrying conduit (the internal melt distribution network 104 being one example thereof) located in a structure, the portion that experiences high tensile stress concentration, in use, and where it is desirable to reduce tensile stress concentration. Examples of such alternative structures and intersections include, but are not limited to, an intersection in a hydraulic manifold, etc.

It should be noted that the two examples of the stress reducing device 202, 302 (i.e. the expanding stress reducing insert 204 and the mechanical stress reducing insert 304) are meant as an example only. Inventors have contemplated that the stress reducing device 202, 302 can be implemented in several form factors, including but not limited to, mechanical means, electromechanical means, thermo-mechanical means, electromagnetic means, piezo-electric means or a combination thereof (i.e. at least one of the listed means). In those embodiments of the present invention, where the stress reducing device 202, 302 is implemented as electromechanical means, piezoelectric means or electromagnetic means, the stress reducing device 202, 302 can be configured for actively applying compressive force or, in other words, applying compressive force when needed (compared to embodiments described above, where compressive force is applied passively or, in other words, the embodiments where the stress reducing device 202, 302 is configured for passively applying compressive force all the time). Put another way, within these embodiments of the present invention, the stress reducing device 202, 302 can be configured to apply compressive force onto an increased tensile stress area (such as the intersection 112) at a precise time when the tensile stresses are experienced, for example, due to the injection pressure. Timing of the application of the compressive forces could be controlled by a suitable close-loop arrangement, known to those of skill in the art, based on feedback from the molding machine (not depicted) and/or a pressure transducer (not depicted) mounted thereon.

Given the architectures described with reference to FIG. 2 and FIG. 3, it is possible to execute a method for local reducing of tensile stress concentration in an area that experiences, in use, higher tensile stress concentration (ex. the intersection 112). The method includes applying the stress reducing the insert 203, 303 proximate to the area that experiences increased tensile stress concentration, whereby the insert 203, 303 is configured to apply, in use, compressive force onto the area during use in order to at least reduce tensile stress experienced in the area.

A technical effect of embodiments of the present invention involves provision of a hot runner manifold 100 having an internal melt distribution network 104 with an intersection 112 that experiences, in use, less of tensile stress concentration. Another technical effect of some embodiments of the present invention provides for a greater choice in selecting materials for manufacturing the body 102 of the hot runner manifold 100. Another technical effect of some embodiments of the present invention provides for an ability to use a cheaper material for manufacturing the body 102 of the hot runner manifold 100 for use for a higher injection pressure application. It should be expressly understood that not each and every technical effect, in their entirety, needs to be enjoyed in each and ever embodiment of the present invention.

Description of the non-limiting embodiments of the present inventions provides examples of the present invention, and these examples do not limit the scope of the present invention. It is to be expressly understood that the scope of the present invention is limited by the claims. The concepts described above may be adapted for specific conditions and/or functions, and may be further extended to a variety of other applications that are within the scope of the present invention. Having thus described the non-limiting embodiments of the present invention, it will be apparent that modifications and enhancements are possible without departing from the concepts as described. Therefore, what is to be protected by way of letters patent are limited only by the scope of the following claims:

What is claimed is:

1. A stress reducing device comprising:
an insert positionable, in use, proximate to an area of a fluid-carrying conduit that experiences increased tensile stress concentration, the insert being configured to apply, in use, compressive force onto the area.

2. The stress reducing device of claim 1, the fluid-carrying conduit being an internal melt distribution network of a hot runner manifold, and wherein the area is an intersection of the internal melt distribution network.

3. The stress reducing device of claim 2, wherein the insert comprises an expanding stress reducing insert, the expanding stress reducing insert made of a material having a relatively high thermal expansion index.

4. The stress reducing device of claim 3, the material being a first material, and wherein:
the expanding stress reducing insert comprises a first rod and a second rod positionable into a first receptacle and a second receptacle, respectively, defined within a body of the hot runner manifold, the first rod and the second rod made of the first material having a first thermal expansion index, the first thermal expansion index being greater than a second thermal expansion index associated with a second material used for manufacturing the body of the hot runner manifold.

5. The stress reducing device of claim 4, wherein the first receptacle and the second receptacle are located, respectively, at a first location and a second location relative to the intersection.

6. The stress reducing device of claim 5, wherein each of the first rod and the second rod are spaced by a distance from the intersection, the distance selected based on an amount of compressive force desired.

7. The stress reducing device of claim 4, wherein the first receptacle is located above the intersection and the second receptacle is located below the intersection.

8. The stress reducing device of claim 4, wherein the first rod and the first receptacle are sized to provide interference fit therebetween.

9. The stress reducing device of claim 4, wherein the second rod and the second receptacle are sized to provide interference fit therebetween.

10. The stress reducing device of claim 4, wherein the first rod and the first receptacle are sized as to not provide interference fit therebetween.

11. The stress reducing device of claim 4, wherein the second rod and the second receptacle are sized as to not provide interference fit therebetween.

12. The stress reducing device of claim 4, wherein each of the first rod and the second rod is provided with an auxiliary force adjustment mechanism for adjusting amount of compressive force.

13. The stress reducing device of claim 2, wherein the insert comprises a mechanical stress reducing insert configured to apply, in use, compressive force onto the intersection.

14. The stress reducing device of claim 13, wherein the mechanical stress reducing insert comprises:
a first insert member positionable at a first location; and
a second insert member positionable at a second location.

15. The stress reducing device of claim 14, wherein the first insert member comprises
a load inducing piece; and
a retaining piece for operatively retaining the load inducing piece in a receptacle defined within a body of the hot runner manifold.

16. The stress reducing device of claim 15, wherein said load inducing piece is made of a first material having a relatively high thermal expansion index compared to a second material used for manufacturing the body of the hot runner manifold.

17. The stress reducing device of claim 14, wherein the second insert member comprises
a load inducing piece; and
a retaining piece for operatively retaining the load inducing piece in a receptacle defined within a body of the hot runner manifold.

18. The stress reducing device of claim 17, wherein said load inducing piece is made of a first material having a relatively high thermal expansion index compared to a second material used for manufacturing the body of the hot runner manifold.

19. The stress reducing device of claim 14, wherein said first insert member and said second insert member are part of a first set, and wherein the stress reducing device comprises a second set being substantially the same as said first set.

20. The stress reducing device of claim 1, wherein said insert comprises at least one of:
mechanical means,
electromechanical means,
thermo-mechanical means,
electromagnetic means, and
piezo-electric means.

21. A hot runner manifold comprising:
a body housing:
an internal melt distribution network for distributing melt from an inlet to a drop;
a heating arrangement, configured to maintain, in use, the internal melt distribution network at an operational temperature;
the internal melt distribution network comprising an area that experiences increased tensile stress concentration;
a stress reducing device including:
an insert positionable, in use, proximate to the area; the insert being configured to apply, in use, compressive force onto the area.

22. The hot runner manifold of claim 21, wherein the area is an intersection within the internal melt distribution network.

23. The hot runner manifold of claim 22, wherein the insert comprises an expanding stress reducing insert, the expanding stress reducing insert made of a material having a relatively high thermal expansion index.

24. The hot runner manifold of claim 23, the material being a first material, and wherein:
the expanding stress reducing insert comprises a first rod and a second rod positionable into a first receptacle and a second receptacle, respectively, defined within the body the hot runner manifold, the first rod and the second rod made of the first material having a first thermal expansion index, the first thermal expansion index being greater than a second thermal expansion index associated with a second material used for manufacturing the body of the hot runner manifold.

25. The hot runner manifold of claim 24, wherein the first receptacle and the second receptacle are located, respectively, at a first location and a second location relative to the intersection.

26. The hot runner manifold of claim 25, wherein each of the first rod and the second rod are spaced by a distance from the intersection.

27. The hot runner manifold of claim 24, wherein the first receptacle is located above the intersection and the second receptacle is located below the intersection.

28. The hot runner manifold of claim 24, wherein the first rod and the first receptacle are sized to provide interference fit therebetween.

29. The hot runner manifold of claim 24, wherein the second rod and the second receptacle are sized to provide interference fit therebetween.

30. The hot runner manifold of claim 24, wherein the first rod and the first receptacle are sized as to not provide interference fit therebetween.

31. The hot runner manifold of claim 24, wherein the second rod and the second receptacle are sized as to not provide interference fit therebetween.

32. The hot runner manifold of claim 24, wherein each of the first rod and the second rod is provided with an auxiliary force adjustment mechanism for adjusting amount of compressive force.

33. The hot runner manifold of claim 22, wherein the insert comprises a mechanical stress reducing insert configured to apply, in use, compressive force onto the intersection.

34. The hot runner manifold of claim 33, wherein the mechanical stress reducing insert comprises:
a first insert member positionable at a first location; and
a second insert member positionable at a second location.

35. The hot runner manifold of claim 34, wherein the first insert member comprises
a load inducing piece; and
a retaining piece for operatively retaining the load inducing piece in a receptacle defined within the body of the hot runner manifold.

36. The hot runner manifold of claim 35, wherein said load inducing piece is made of a first material having a relatively high thermal expansion index compared to a second material used for manufacturing the body of the hot runner manifold.

37. The hot runner manifold of claim 34, wherein the second insert member comprises
a load inducing piece; and
a retaining piece for operatively retaining the load inducing piece in a receptacle defined within the body of the hot runner manifold.

38. The hot runner manifold of claim 37, wherein said load inducing piece is made of a first material having a relatively high thermal expansion index compared to a second material used for manufacturing the body of the hot runner manifold.

39. The hot runner manifold of claim 34, wherein said first insert member and said second insert member are part of a first set, and wherein the stress reducing device comprises a second set being substantially the same as said first set.

40. The hot runner manifold of claim 21, wherein said insert comprises at least one of:
mechanical means,
electromechanical means,
thermo-mechanical means,
electromagnetic means, and
piezo-electric means.

41. A stress reducing device comprising:
an insert positionable, in use, proximate to an area within a structure; the area that experiences increased tensile stress concentration, the insert being configured to apply, in use, compressive force onto the area.

42. The stress reducing device of claim 41, wherein the structure is a hot runner manifold having an internal melt distribution network, and wherein the area is a portion of the internal melt distribution network.

43. The stress reducing device of claim 42, wherein the area is an intersection of the internal melt distribution network.

44. The stress reducing device of claim 41, wherein the structure is a hydraulic manifold; and wherein the area is an intersection of the hydraulic manifold.

45. The stress reducing device of claim 41, wherein said insert comprises at least one of:
mechanical means,
electromechanical means,
thermo-mechanical means,
electromagnetic means, and
piezo-electric means

46. A method for local reducing of tensile stress concentration in an area of a fluid-carrying conduit that experiences, in use, higher tensile stress concentration, the method comprising:
applying an insert proximate to the area, the insert being configured to apply, in use, compressive force onto the area to at least reduce tensile stress experienced in the area.

47. The method of claim 46, further including actively applying compressive force onto the area.

48. The method of claim 46, further including passively applying compressive force onto the area.
